(19) United States
(12) Patent Application Publication
(10) Pub. No.: US 2016/0154796 A1
(43) Pub. Date: Jun. 2, 2016

(54) METHOD, SYSTEM AND APPARATUS FOR DYNAMICALLY CONTROLLING WEB-BASED MEDIA GALLERIES

(71) Applicant: IGNU INC., Toronto (CA)

(72) Inventor: Daniel DAHAN, Toronto (CA)

(21) Appl. No.: 14/555,931

(22) Filed: Nov. 28, 2014

(51) Int. Cl. G06F 17/30

(52) U.S. Cl. CPC G06F 17/3028; G06F 17/30864

(57) ABSTRACT

A method is provided of dynamically updating sequence data for media files in a media gallery. The method includes: receiving at a control server via a network, from a client device displaying the media gallery according to the sequence data, event data defining an interaction with a first media file in the media gallery; at the control server, storing the event data in a first database as a plurality of nodes; at the control server, determining whether the event data represents a selection of the first media file; and when the determination is affirmative, incrementing a counter corresponding to the first media file. In response to a subsequent request for the gallery, the control server generates updated sequence data for the gallery based on the counter.

### FIELD

The specification relates generally to web-based image galleries, and specifically to a method, system and apparatus for dynamically controlling such web-based image galleries.

### BACKGROUND

Web-based media (e.g. images, videos) galleries are common, for example on travel websites such as those operated by hotels. Media for such galleries may be selected and arranged manually and in an ad-hoc fashion. Such manual selection and arrangement of media in web-based galleries may be time-consuming and error-prone, and thus makes inefficient use of available computing resources.

### BRIEF DESCRIPTIONS OF THE DRAWINGS

Embodiments are described with reference to the following figures, in which:

FIG. 1 depicts a communication system, according to a non-limiting embodiment;

FIGS. 2A and 2B depict a web page with a gallery in the system of FIG. 1, according to a non-limiting embodiment;

FIG. 3 depicts the control server of FIG. 1, according to a non-limiting embodiment;

FIG. 4 depicts a method in the control server of FIG. 1, according to a non-limiting embodiment;

FIG. 5 depicts example nodes stored by the control server of FIG. 1, according to a non-limiting embodiment;

FIG. 6 depicts further example nodes stored by the control server of FIG. 1, according to a non-limiting embodiment;

FIG. 7 depicts a continuation of the method of FIG. 4, according to a non-limiting embodiment;

FIG. 8 depicts an updated web page in the system of FIG. 1, according to a non-limiting embodiment;

FIG. 9 depicts logical groupings of the components of the control server of FIG. 1, according to a non-limiting embodiment;

### DETAILED DESCRIPTION OF THE EMBODIMENTS

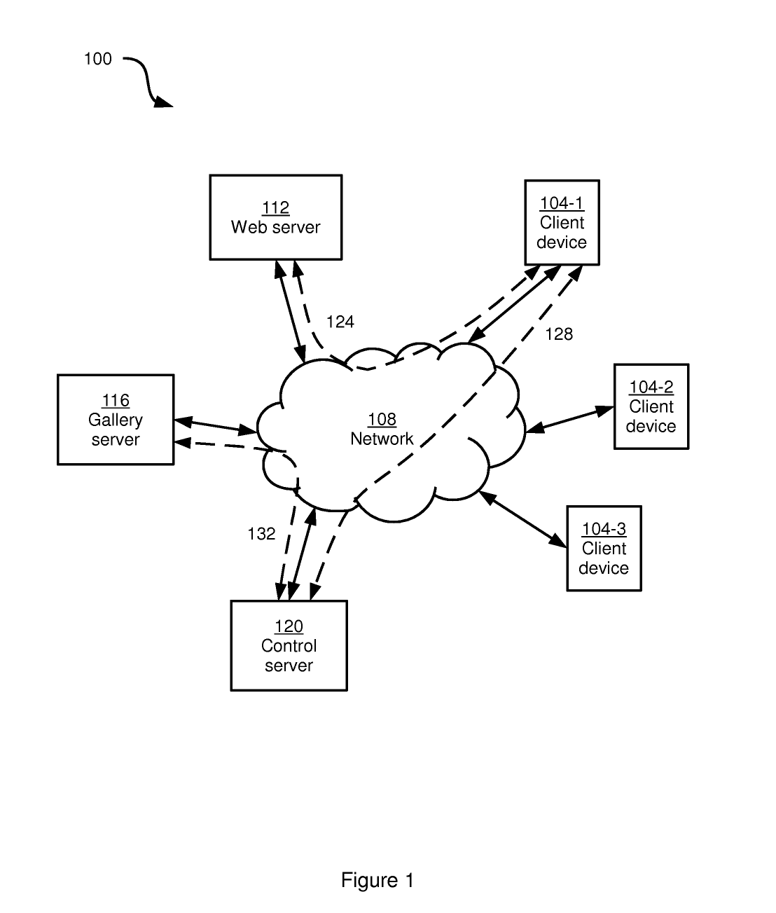

FIG. 1 depicts a communications system 100 including a plurality of client computing devices, of which three examples 104-1, 104-2 and 104-3 are illustrated (referred to generically as a client computing device or client device 104, and collectively as client computing devices or client devices 104). Each client device 104 can be any one of a cellular phone, a smart phone, a tablet computer, a desktop computer, and the like. Thus, client devices 104 each include hardware components such as processors, memories, network interfaces, input and output devices, and the like.

Client devices 104 are connected to a network 108 via communications links that can be wired, wireless, or any suitable combination of wired and wireless. Network 108 can include any suitable combination of wired and wireless networks, including but not limited to a Wide Area Network (WAN) such as the Internet, a Local Area Network (LAN) such as a corporate data network, cell phone networks, WiFi networks, WiMax networks and the like.

Via network 108, client devices 104 can communicate with other computing devices, including a web server 112 hosting one or more web pages, and a gallery server 116. Web server 112 and gallery server 116 can each be based on any suitable computing platform, and thus each include at least one processor, a memory, a network interface, and the like. In some embodiments, web server 112 and gallery server 116 can be integrated into a single computing device, as will become apparent to those skilled in the art in the discussion below. For illustrative purposes, however, web server 112 and gallery server 116 will be described as separate devices. System 100 also includes a control server 120 connected to network 108, whose functions will be described in detail herein.

In brief, client devices 104 can request the above-mentioned web page from web server 112, and receive the web page from web server 112 over network 108 (see signal path 124). The web page includes a media gallery, to be discussed in greater detail below, that is hosted by gallery server 116. Thus, once the web page has been received from web server 112 at client device 104-1, client device 104-1 sends a further request for the media gallery.

The gallery hosted by gallery server 116 comprises a set of computer-readable instructions (e.g. a software object for execution by the processor of client device 104-1) and one or more media files such as images or videos. The gallery's instructions configure client device 104-1 to display the media files within the web page received from web server 112. The gallery also includes sequence data specifying an order in which the media files are to be displayed at client device 104-1. In addition, the media files are selectable when displayed at client device 104-1, and thus client device 104-1 can be controlled (e.g. by an operator, via a touch screen) to display the media files in a different order than that specified by the sequence data. In the present example, gallery server 116 hosts both the media itself (e.g. the image and video files) and the data identifying the media files and their sequence. In other embodiments, the media and the identifying and sequence data may be stored separately.

Having received the web page from web server 112, client device 104-1 requests the media gallery from a control server 120 (see signal path 128) connected to network 108. Client device 104-1 is also configured (via execution of the instructions contained in the media gallery) to report interactions with the gallery at client device 104-1 (e.g. the selection of an image for display at client device 104-1) to control server 120 as event data.

Control server 120 is therefore configured to receive requests for galleries from client devices 104, and event data describing interactions with the galleries at client devices 104. Control server 120 is configured to respond to requests for galleries by retrieving the requested galleries from gallery server 116 (see signal path 132), and sending the retrieved gallery to the requesting client device 104. The gallery sent from control server 120 to client device 104-1 can include the media files themselves, or can include only the above-mentioned instructions and metadata (a sequence of the media files and identifiers of the files, to be used by client device 104-1 to retrieve the media files via network 108).

Before providing the gallery (including at least the sequencing data) to client device 104-1, however, control server 120 is configured to automatically and dynamically alter the sequencing data from its state as received from gallery server 116. The dynamic alterations to sequencing data are performed by control server 120 based on event data received from client devices 104, as will be discussed below in greater detail.

Before discussing the functionality of control server 120 in detail, an example web page and image gallery will be discussed, followed by a brief discussion of certain internal components of control server 120.

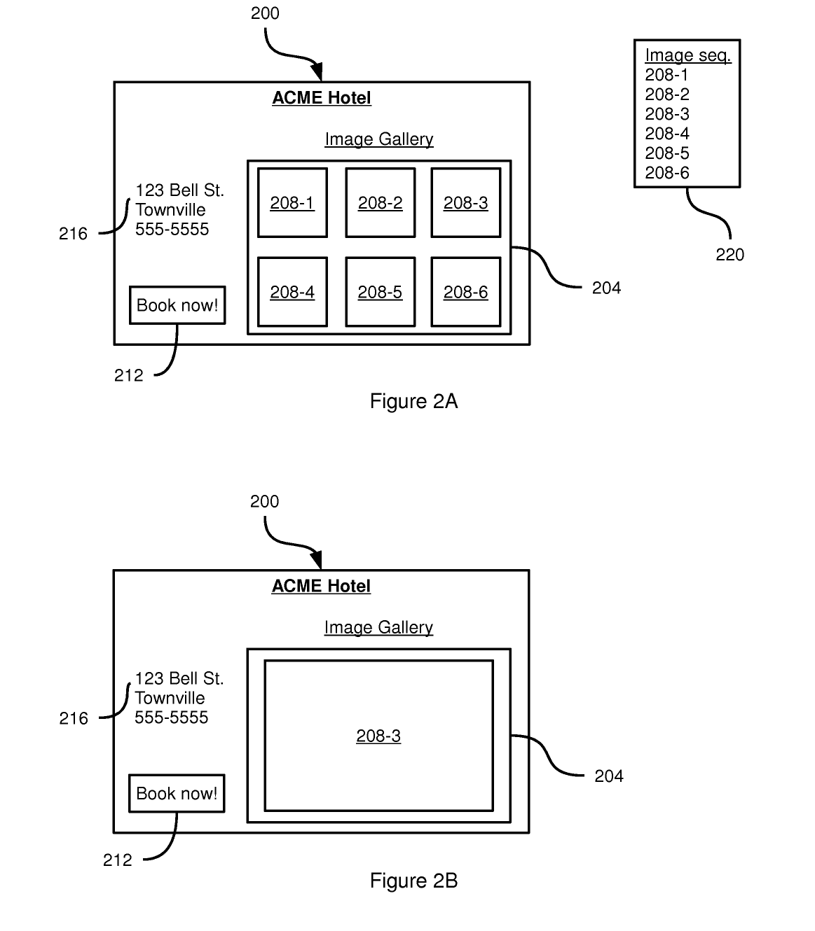

Turning to FIG. 2A, an example web page 200 is illustrated, as presented on a display of a client device 104. Web page 200, in the present example, is a web page containing information about a hotel. Web server 112 can therefore be (but need not be) operated by the hotel, while gallery server 116 can be operated by a service provider contracted by the hotel. In other examples, however, web server 112 and gallery server 116 may be operated by entities other than the hotel, or may both be operated by the hotel.

The contents of web page 200 is not particularly limited, and a wide variety of such web pages will now occur to those skilled in the art. A gallery 204 is embedded within web page 200. The retrieval of web page 200 by client device 104-1, as mentioned above, includes receiving web page 200 from web server 112 and receiving gallery 204 from control server 120 (which in turn received gallery 204 from gallery server 116). Image gallery 204 contains a plurality of thumbnail images 208-1, 208-2, 208-3, 208-4, 208-5, 208-6, each corresponding to an image of the hotel, a room within the hotel, a surrounding area, and the like. In some embodiments, thumbnail images 208 are lower-resolution versions of the corresponding images, while in other embodiments thumbnail images 208 and the corresponding “full” images are the same files, simply displayed at different physical sizes. As mentioned earlier, the actual image files (or any other form of media, such as video files) can be received from control server, or can be retrieved by client devices 104 from another computing device (such as gallery server 116) using identifiers provided by control server 120.

Web page 200 can also include other selectable elements, such as a booking element 212 for initiating an electronic booking process to secure a room at the hotel. Additional selectable elements will also occur to those skilled in the art. Other data, such as a hotel address 216, may also be included in web page 200.

As seen in FIG. 2A, images 208 are presented in an order specified by sequence data 220 contained within gallery 204 (but not necessarily explicitly presented on the display of the client device 104). Any one of images 208 can be selected at the client device 104 to cause the client device 104 to present the image 208 in enlarged form (to the exclusion of the other images 208) within gallery 204. Referring to FIG. 2B, an updated rendering of web page 200 is illustrated, following a selection at the client device 104 of thumbnail image 208-3. Image 208-3 is presented in a larger format in image gallery 204, and the remaining images 208 are no longer visible. In other embodiments, the other images may remain visible, for example along the bottom of gallery 204, still in the order specified by sequence data 220. In some examples, gallery 204 can also include a selectable element (not shown) for advancing from the view of FIG. 2B to the next image 208 in the sequence (image 208-4 in the present example).

Having described web page 200 and gallery 204, certain internal components of control server 120 will now be discussed, following which the functionality of control server 120 will be described in detail.

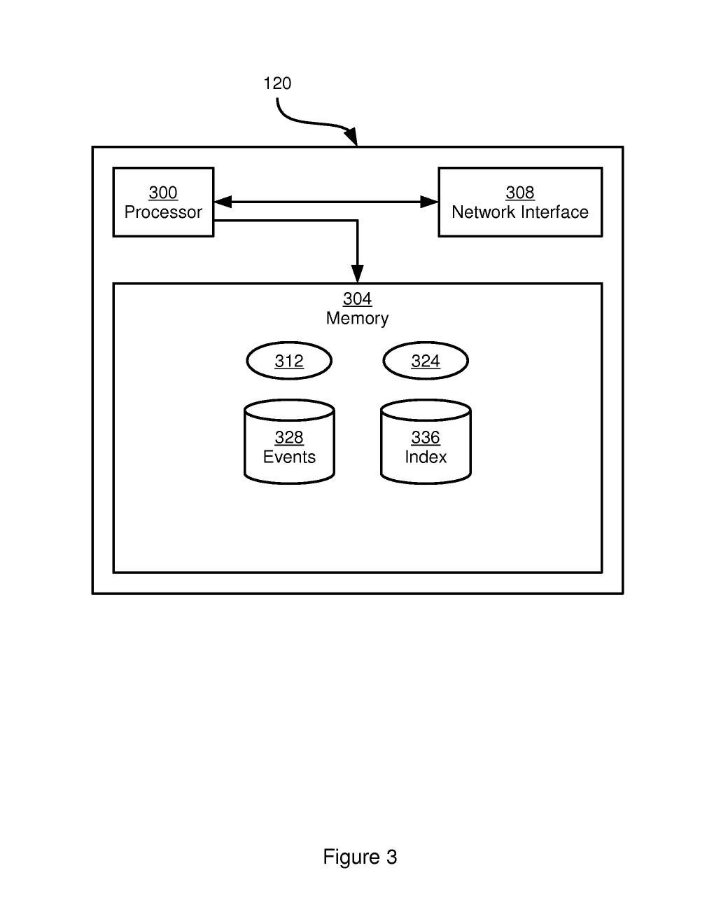

Referring to FIG. 3, a schematic diagram of certain internal components of control server 120 is depicted. Control server 120 includes at least one central processing unit (also referred to as a microprocessor or simply a processor) 300 interconnected with at least one non-transitory computer readable storage medium such as a memory 304.

Processor 300 and memory 304 are generally comprised of one or more integrated circuits (ICs), and can have a variety of structures, as will now occur to those skilled in the art (for example, more than one CPU can be provided). Memory 304 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 304 includes both a volatile memory and a non-volatile memory. Other types of non-transitory computer readable storage medium are also contemplated, such as compact discs (CD-ROM, CD-RW) and digital video discs (DVD).

Control server 120 also includes a network interface 308 interconnected with processor 300. Network interface 308 allows control server 120 to communicate with other computing devices (e.g. image server 116) via network 108. Network interface 308 thus includes any necessary hardware for communicating over such networks, network interface controllers (NICs), radios and the like.

Control server 120 can also include input devices (not shown) such as a keyboard and mouse, as well as output devices (not shown) such as a display. Such input and output devices can be connected to processor 300 directly, for example via a USB connection, or remotely via another computing device (not shown). In other words, the input and output devices used for operator control of control server 120 can be local or remote to control server 120.

Control server 120 stores, in memory 304, a plurality of applications each comprising a plurality of computer-readable instructions that are executable by processor 300. In particular, memory 304 stores an event recordal application 312, and a sequencing application 324 (respectively referred to herein as applications 312 and 324).

When processor 300 executes the instructions of each of applications 312 and 324, processor 300 performs various functions implemented by those instructions, as will be discussed below. Processor 300, or control server 120 more generally, is therefore said to be “configured” to perform those functions via the execution of the above-mentioned applications.

Also stored in memory 304 are various data repositories, including an events database 328, and a media metadata index 336. The contents of each of the above-mentioned repositories will be detailed below.

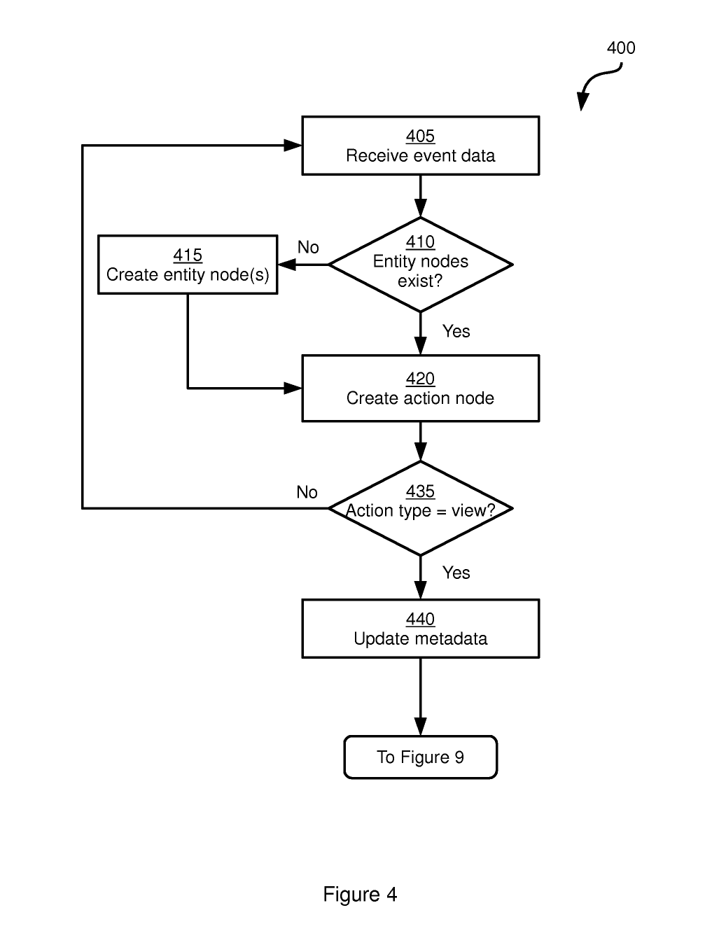

As stated earlier, control server 120 is configured to receive event data from client devices 104 (the event data representing interactions with image gallery 204 at client devices 104), and to respond to requests for gallery 204 (or any other of a plurality of galleries hosted by gallery server 116) from client devices 104 by retrieving gallery 204 from gallery server 116, updating the sequencing of media files in gallery 204 and returning the updated gallery to the requesting client devices 104. The handling of event data and the generation of sequence data at control server 120 will now be described in detail, with reference to FIG. 4.

FIG. 4 depicts a method 400 of dynamically updating an image gallery. Method 400 will be discussed in conjunction with its performance in system 100, and in particular, the blocks of method 400 will be described as being performed by control server 120. It will be apparent to those skilled in the art, however, that method 400 can also be implemented in other systems and on other servers.

Beginning at block 405, control server 120 is configured to receive event data from a client device 104, defining one or more interactions with image gallery 204 at that client device 104. In general, an interaction defined by the event data comprises the selection of a selectable element of gallery 204, such as an image 208. As noted earlier, gallery 204 includes computer-readable instructions that cause client devices 104 to report activity related to gallery 204 to control server 120.

The format in which the event data is received at block 405 is not particularly limited. In general, the event data includes an identifier associated with gallery 204, an identifier of the media file within gallery 204 that was interacted with at the client device 104, and an indication of the type of interaction with that element. Thus, for example, when image 208-3 as illustrated in FIG. 2A is selected (e.g. by depression of a touch screen on client device 104-1), client device 104-1 reports the selection to control server 120 via network 108. The event data can also include other parameters, such as the date and time.

The media identifiers in the event data can be, for example, file names or other identifiers employed by gallery server 116. The gallery identifiers can also be file names or other identifiers employed by gallery server 116 to distinguish various galleries from each other. Thus, for example, the following event data is assumed to be received at block 405:

TABLE 1
Example event data from image server 116

| Gallery ID | Media ID | Action | Timestamp |
|---|---|---|---|
| 204 | 208-3 | View | 11/23/2014; 08:00 |

The format of the event data received at control server 120 can vary widely, and the tabular format shown above is provided solely for illustrative purposes.

Having received event data at block 405, control server 120 is configured to determine, at block 410, whether any nodes corresponding to the entity (e.g. gallery and media) identifiers in the received event data exist in events database 328. The determination at block 410 is performed by inspecting database 328 to determine whether a node already exists with the received gallery identifier, or whether a node already exists with the received media identifier (no check is performed in connection with the type of action in the event data). A discussion of nodes and their structures will be provided below.

In the present example performance of method 400, it is assumed that events database 328 is empty, and thus the determination at block 410 is negative. Control server 120 thus proceeds to block 415 and creates nodes corresponding to the entities (gallery and media) defined in the event data received at block 405. Having created the entity nodes at block 415, control server 120 then creates a node corresponding to the action defined in the event data at block 420. When the determination is affirmative at block 410, control server proceeds directly to block 420, without creating entity nodes. In other embodiments, at block 420 control server 120 can also make updates to existing entity nodes.

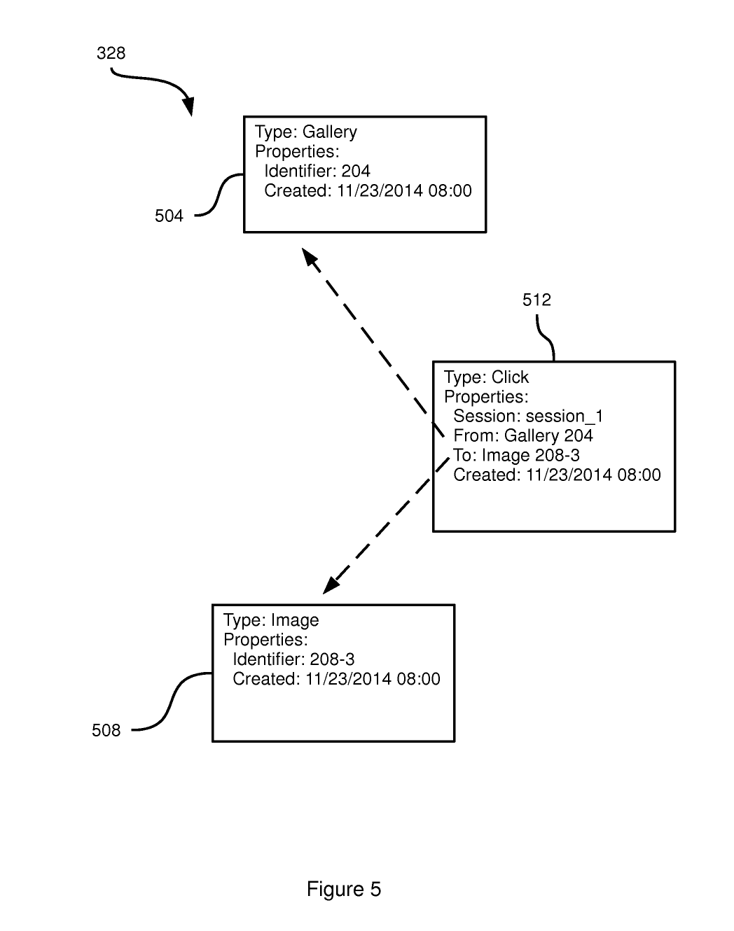

Turning to FIG. 5, an example of database 328 following the performance of blocks 415 and 420 is illustrated. Database 328 is a graph database, which in the present example is structured according the known graph database engine Neo4j™. Database 328 thus includes a plurality of nodes. In general, each event defined by event data received at block 405 results in the creation or updating of three nodes: a node corresponding to gallery 204 (or any other gallery being interacted with at a client device 104), a node corresponding to the selected media element of gallery 204 (e.g. an image), and a node corresponding to the action performed at client device 104 with respect to that media element. The action can be, for example, a selection action (referred to herein as a “view”, indicating activation of an input device at client device 104 to select the media element) or a load action (indicating that the media element has been presented on the display of client device 104-1, but not in response to an input device activation). In other words, the nodes of database 328 represent entities (galleries such as gallery 204 and media such as images 208) and actions (such as selections of images 208 by client devices 104).

Thus, at blocks 415 and 420, control server 120 is configured to create three nodes 504, 508 and 512 in database 328, and to update those nodes to contain the event data received at block 405. Each node contains various data fields, including a node type and one or more node properties. In the present example, node 504 corresponds to gallery 204 and thus includes a node type field indicating that node 504 represents a gallery. Node 504 also includes properties in the form of a gallery identifier and a creation timestamp containing the time and date at which node 504 was created in database 328. Control server 120 can be configured to apply constraints to nodes, such as a constraint that the gallery identifier property must be unique.

Node 508 includes a node type field indicating that node 508 represents an image, as well as properties including an identifier of the image represented by node 508 and a creation timestamp as described above relative to node 504. Other node type identifiers are also contemplated (e.g. particular types of image, types of video, and the like). Control server 120 stores a preconfigured list of known media types.

Node 512, meanwhile, establishes a link (represented by dashed arrows in FIG. 5) between nodes 504 and 508. Node 512 thus includes a type field indicating that node 512 represents an action (in particular, a “view” or selection action) rather than an entity (e.g. gallery or image). Node 512 also contains properties including a creation timestamp, a source (“from”) identifier and a destination (“to”) identifier. The source and destination properties indicate the entities to which the action defined by node 512 relates (in the present example, gallery 204 and image 208-3). Node 512 also contains a session identifier property: control server 120 can be configured to assign a session identifier to any request received by a client device 104. The same session identifier will be used for any further nodes generated in response to event data from that same client device 104, until a predetermined time period passes without activity from that client device 104 (e.g. twenty-four hours).

Blocks 405, 410, 415 and 420 are performed by control server 120 via the execution (by processor 300) of event recordal application 312. Following the storage of event data at block 420, control server 120 is configured to perform block 435 of method 400. Block 435, like blocks 405, 410, 415 and 420, is performed by control server 120 via the execution of application 312.

At block 435, control server 120 determines whether the type of the action node created at block 420 is “view”. In other words, the determination at block 435 is whether the media element defined in the event data received at block 405 was explicitly selected by the operator of the client device 104. If the determination at block 435 is negative, the performance of method 400 returns to block 405 to await the next event data. When the determination at block 435 is affirmative, however, control server 120 proceeds to block 440.

At block 440, which is also performed via the execution of application 312, control server 120 is configured to update metadata in index 336 associated with the media element referred to in the event data received at block 405. In particular, the metadata is a weighted counter representing the number of times that media element has been selected. An example of index 336 is shown below:

TABLE 2
Example Index 336

| Gallery | Media | Value |
|---|---|---|
| 204 | Image 208-3 | 3 |

Index 336, in the present example, is implemented using the known Redis™ data structure server. Index 336 includes, for each gallery (in the present example, only gallery 204), a set of key/value pairs for the media contained within the gallery. In the present example, since event data has only been received for image 208-3, the set for gallery 204 currently only contains a single key/value pair. As seen above, one selection of image 208-3 results in incrementing the value corresponding to image 208-3 by three. Other increment values can also be implemented.

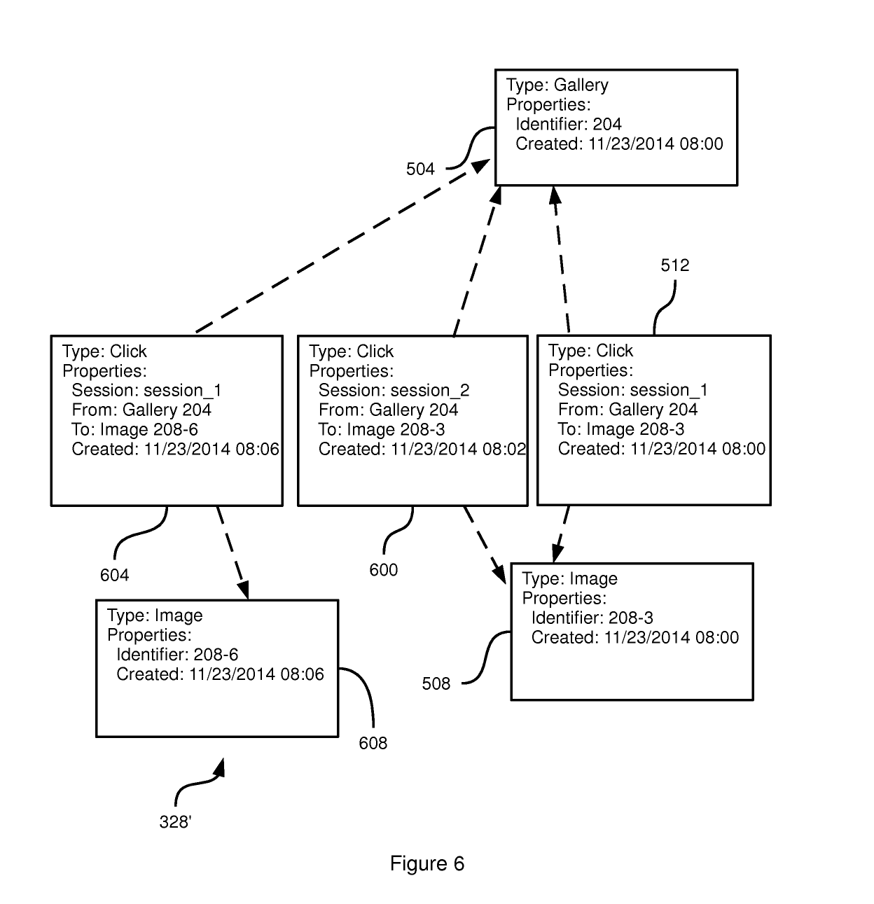

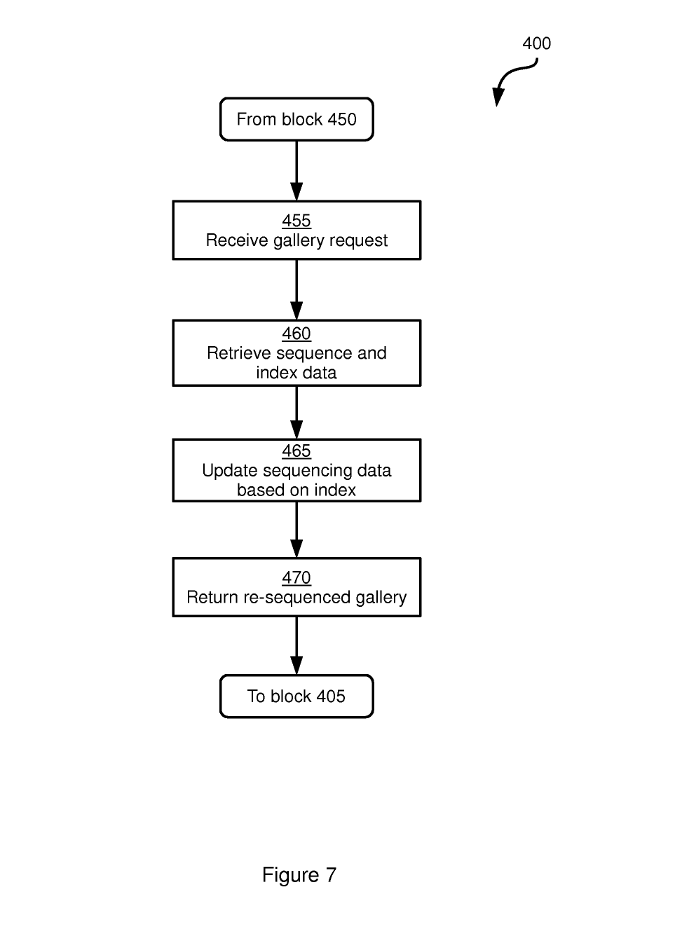

Following the performance of block 440, control server 120 proceeds to block 455, illustrated in FIG. 7. Before discussing the performance of block 455 and subsequent blocks of method 400, it is assumed that additional performances of blocks 405 to 440 result in the creation and updating of additional nodes in database 328, and additional updates to index 336. Referring to FIG. 6, an updated database 328′ is shown, including nodes 504, 508 and 512. In addition, database 328′ includes additional nodes 600, 604 and 608 which represent, respectively, an additional selection of image 208-3 (in a different client session), and a selection of another image (image 208-6, represented by node 608) in gallery 204.

Following the repeated performances of method 400 in response to the above-mentioned event data, index 336 has the following contents:

TABLE 3
Updated Index 336

| Gallery | Media | Value |
|---|---|---|
| 204 | Image 208-3 | 6 |
| | Image 208-6 | 3 |

Returning to FIG. 7, the remaining blocks of method 400 are performed by control server 120 via the execution of application 324. At block 455 control server 120 is configured to receive a gallery request from a client device 104. For example, a request for gallery 204 can be received from client device 104-2. Having received the request, control server 120 sends a request to gallery server 116 at block 460 for at least the sequencing data for that gallery (the request can be for other data as well, up to and including the entirety of the requested gallery, including all instructions and media files). Thus, at block 460 control server 120 receives sequencing data 220 shown in FIG. 2.

Also at block 460, control server 120 is configured to retrieve data from index 336 that corresponds to the requested gallery. Thus, at block 460 control server 120 retrieves the contents of Table 3 above.

At block 465, control server 120 generates updated sequencing data from the sequencing data received at block 460, based on the index data retrieved at block 460. In general, the sequencing data received at block 460 is re-ordered to place the media identifiers having the highest corresponding values in index 336 first. Any media identifiers that do not appear in index 336 are placed after media identifiers that do appear in index 336, in the order they originally appeared in.

At block 470, having dynamically re-sequenced the media in gallery 204, control server 120 returns the re-sequenced gallery to client device 104-2 in response to the request received at block 455.

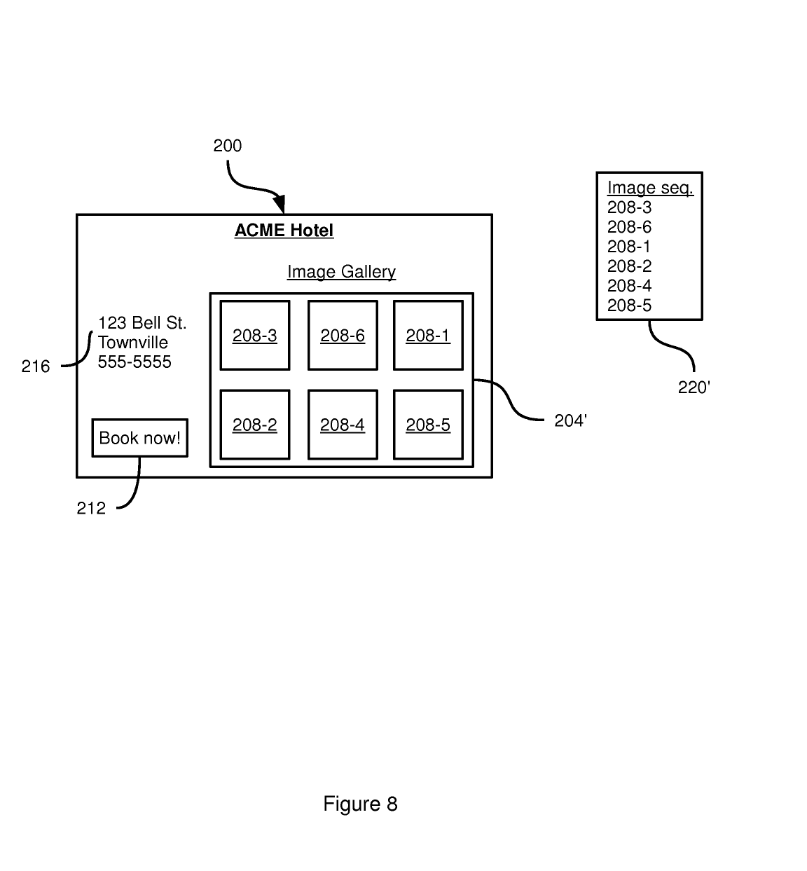

Turning to FIG. 8, a further example of web page 200 is shown as rendered on a display of a client device 104. Certain portions of web page 200 (e.g. 212, 216) are unchanged. However, image gallery 204 has been updated and thus appears as image gallery 204′, in which image 208-3 is presented first, and image 208-6 is presented second. The order of presentation of images 208 is influenced by revised sequencing data 220′ received at image server 116 from control server 120. It is noted that sequencing data 220′ specifies sequence positions for images 208-1, 208-2, 208-4 and 208-5 that are equivalent to their original positions, with the exception of the relocation of images 208-3 and 208-6.

Various advantages to the above systems and methods will now occur to those skilled in the art. For example, the automatic updating of sequencing data by control server 120 reduces or eliminates the need for manual construction of image galleries. In addition, the collection of event data based upon which the sequencing data is generated allows the unpredictable actions of the operators of client devices 104 to act as feedback on the structure of image galleries, again automatically and without the need for any manual intervention by the operators of image server 116 or control server 120.

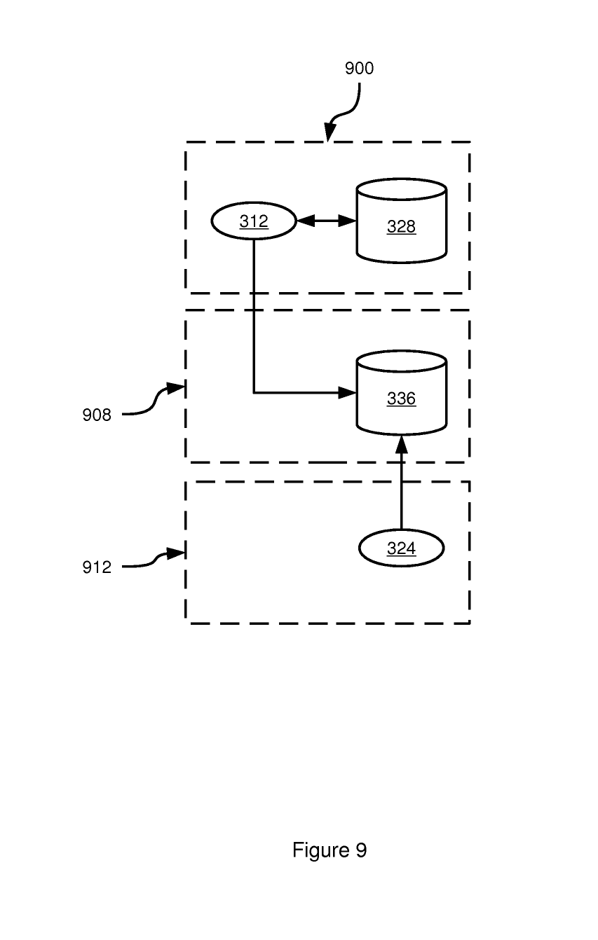

Variations to the above systems and methods are contemplated. For example, although the applications and databases described herein are illustrated in FIG. 3 as being hosted on control server 120, in other embodiments they may be separated among many computing devices. For example, referring to FIG. 9, the applications and databases originally shown in FIG. 3 are depicted in four logical groupings. The first grouping, 900, contains event recordal application 312 and event database 328. The second grouping, 908, contains index 336. The third grouping, 912, contains sequencing application 324.

Each of the above-mentioned groupings 900, 908 and 912 can be implemented on a separate logical computing device, and any logical device may be implemented on one or a plurality of physical computing devices (such as control server 120 illustrated earlier). Thus, in some implementations, grouping 900 can be implemented on a bank of servers acting as a single logical device, while groupings 908 and 912 can all be implemented on a single logical and physical device. A wide variety of other implementations will also now occur to those skilled in the art.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method of dynamically updating sequence data for media files in a media gallery, comprising:
receiving at a control server via a network, from a client device displaying the media gallery according to the sequence data, event data defining an interaction with a first media file in the media gallery;
at the control server, storing the event data in a first database as a plurality of nodes;
at the control server, determining whether the event data represents a selection of the first media file; and
when the determination is affirmative, incrementing a counter corresponding to the first media file.

2. The method of claim 1, wherein the plurality of nodes comprise a first node corresponding to the media gallery, a second node corresponding to the media file, and a third node corresponding to the interaction.

3. The method of claim 2, wherein the third node contains references to the first and second nodes.

4. The method of claim 1, further comprising:
receiving, at the control server from the client device, further event data defining a further interaction with a second media file in the media gallery;
at the control server, storing the further event data in the first database;
at the control server, determining whether the further event data represents a selection of the second media file; and
when the determination is affirmative, incrementing a counter corresponding to the second media file.

5. The method of claim 4, wherein storing the further event data comprises creating a fourth node corresponding to the further interaction, the fourth node containing references to the first and second nodes.

6. The method of claim 4, further comprising storing the counters corresponding to the first and second media files in association with an identifier of the gallery.

7. The method of claim 4, further comprising:
receiving a request for the media gallery from another client device;
transmitting a query for the media gallery to a gallery server;
responsive to the query, receiving at least the sequence data from the gallery server;
retrieving the counters corresponding to the first and second media files;
generating updated sequence data based on the sequence data and the counters; and
sending the media gallery with the updated sequence data to the other client device.

8. The method of claim 7, wherein the updated sequence data contains an identifier of each media file in the media gallery, and a position corresponding to each media file identifier.

9. The method of claim 8, further comprising assigning the positions to the media file identifiers in descending order of the corresponding counters.

10. The method of claim 1, wherein the media files are selected from the group consisting of image files and video files.

11. The method of claim 1, wherein a selection of the first media file consists of a user selection of the first media file via an input of the client device.

12. A control server, comprising:
a network interface;
a memory; and
a processor configured to perform the method of claim 1.
